(19) United States
(12) Patent Application Publication
(10) Pub. No.: US 2019/0293991 A1
(43) Pub. Date: Sep. 26, 2019

(54) NORMALLY BLACK-TYPE LIQUID CRYSTAL DISPLAY PANEL AND METHOD FOR MANUFACTURING NORMALLY BLACK-TYPE LIQUID CRYSTAL DISPLAY PANEL

(71) Applicant: Sharp Kabushiki Kaisha, Sakai City, Osaka (JP)

(72) Inventors: Ryo YONEBAYASHI, Sakai City (JP); Takayuki NISHIYAMA, Sakai City (JP); Kohhei TANAKA, Sakai City (JP); Tokihiro YOKONO, Sakai City (JP)

(73) Assignee: Sharp Kabushiki Kaisha, Sakai City, Osaka (JP)

(21) Appl. No.: 16/345,250

(22) PCT Filed: Nov. 2, 2017
(86) PCT No.: PCT/JP2017/039777

§ 371 Date: Apr. 26, 2019

(30) Foreign Application Priority Data
Nov. 8, 2016 (JP) 2016-218444

(51) Int. Cl. G02F 1/1335; G02F 1/1343

(52) U.S. Cl. CPC G02F 1/133512; G02F 1/1343; G02F 1/133602; G02F 1/133514

(57) ABSTRACT

Provided is a normally black-type liquid crystal display panel that has high productivity. In a pixel (3) contacting a light shielding layer (5), in order for a difference to be small between an area of a light shielding part in a blue picture element (2B) which has a largest area covered with the light shielding layer (5) and an area of a light shielding part in each of a red picture element (2R) and a green picture element (2G), a picture element electrode (4) is divided in each of the red picture element (2R) and the green picture element (2G).

### TECHNICAL FIELD

The present invention relates to a liquid crystal display panel and a method for manufacturing the liquid crystal display panel.

### BACKGROUND ART

In recent years, there has been a strong demand for a display apparatus with a sophisticated design and a liquid crystal display panel with an odd shape in which an external shape of a housing is smooth and an edge of a display region of the display panel is formed into a curved shape so as to fit with such an external shape of the housing has been actively developed.

FIG. 8(a) is a view illustrating a liquid crystal display panel 100 with an odd shape in which a display region is partially covered with a light shielding layer 103 and has an upper left corner part and an upper right corner part each formed into a curved shape, FIG. 8(b) is an enlarged view of a part A of the liquid crystal display panel 100 with the odd shape illustrated in FIG. 8(a), and FIG. 8(c) is a further enlarged view of the part illustrated in FIG. 8(b).

When the display region is partially covered with the light shielding layer 103 as illustrated in FIG. 8(a), the liquid crystal display panel 100 with the odd shape that has the display region with an odd shape may be implemented, but a pixel 102 contacting the light shielding layer 103 and a pixel 102 not contacting the light shielding layer 103 have different hues in the display region as illustrated in FIG. 8(b), thus posing a problem.

A reason therefor arises from the fact that, in the liquid crystal display panel, a single pixel is constituted by a plurality of picture elements and a display color of the single pixel is decided by controlling a light transmittance of each of the picture elements constituting the single pixel.

As illustrated in FIG. 8(c), a single pixel 102 in the liquid crystal display panel 100 with the odd shape that has the display region with the odd shape is constituted by a red picture element 101R through which red light is transmitted, a green picture element 101G through which green light is transmitted, and a blue picture element 101B through which blue light is transmitted.

Note that, though not illustrated, each of the red picture element 101R, the green picture element 101G, and the blue picture element 101B includes a picture element electrode, a counter electrode, a liquid crystal layer between the picture element electrode and the counter electrode, a color filter layer of a corresponding color, and alignment of liquid crystal molecules in the liquid crystal layer is controlled on the basis of a potential difference between the picture element electrode and the counter electrode and intensity of light passing through color filters of the respective colors is adjusted, and thus a display color of the single pixel 102 is decided.

As illustrated in FIG. 8(c), however, in the display region, the pixel 102 contacting the light shielding layer 103 is different from the pixel 102 not contacting the light shielding layer 103 in that each of the red picture element 101R, the green picture element 101G, and the blue picture element 101B have different areas in which light is shielded by the light shielding layer 103.

For example, in a case of FIG. 8(c), in the display region, the pixel 102 contacting the light shielding layer 103 has a relation of an area of the blue picture element 101B in which light is shielded by the light shielding layer 103>an area of the green picture element 101G in which light is shielded by the light shielding layer 103>an area of the red picture element 101R in which light is shielded by the light shielding layer 103, and the red picture element 101R, the green picture element 101G, and the blue pixel element 101B that constitute the single pixel 102 are different in the area in which light is shielded by the light shielding layer 103, and accordingly the transmittance of the red light, the transmittance of the green light, and the transmittance of the blue light are different from intended transmittances in such a single pixel 102. Thus, in the display region, the pixel 102 contacting the light shielding layer 103 displays a color in which a ratio is different among red, green, and blue, thus posing a problem that the pixel 102 contacting the light shielding layer 103 has a hue different from that of the pixel 102 not contacting the light shielding layer 103.

Then, PTL 1 describes a liquid crystal display panel that addresses such a problem.

FIG. 9 is a view illustrating a schematic configuration of a liquid crystal display panel 170 with an odd shape that has a display region 174 with an odd shape, which is disclosed in PTL 1.

As illustrated in the figure, in the liquid crystal display panel 170, by partially covering the display region with a light shielding layer 172, the liquid crystal display panel 170 with the odd shape that has the display region 174 with the odd shape is implemented.

In order for a red picture element 171R, a green picture element 171G, and a blue picture element 171B that constitute a single pixel to have an equal light transmitted area, widths of black matrix layers 173R, 173G, and 173B and sizes of picture element electrodes in the picture elements 171R, 171G, and 171B are adjusted.

That is, in the liquid crystal display panel 170, the picture elements 171R, 171G, and 171B that constitute a pixel contacting the light shielding layer 172 have shapes different from those of picture elements that constitute a pixel not contacting the light shielding layer 172.

It is described that, according to the configuration disclosed in PTL 1, it is possible to prevent the pixel contacting the light shielding layer 172 from displaying a color in which a ratio is different among red, green, and blue and performing display in which a hue is different from that of the pixel not contacting the light shielding layer 172.

### CITATION LIST

### Patent Literature

PTL 1: Japanese Unexamined Patent Application Publication No. 2006-276580 (published on Oct. 12, 2006)

### SUMMARY OF INVENTION

### Technical Problem

In a case of the configuration disclosed in PTL 1 and illustrated in FIG. 9, however, the picture elements 171R, 171G, and 171B that constitute the pixel contacting the light shielding layer 172 are different in shape from picture elements that constitute the pixel not contacting the light shielding layer 172.

That is, since the shapes of the picture elements 171R, 171G, and 171B that constitute the pixel contacting the light shielding layer 172 need to be adjusted in accordance with a shape of the light shielding layer 172, when the shape of the light shielding layer 172 is changed, the shapes of the picture elements 171R, 171G, and 171B that constitute the pixel contacting the light shielding layer 172 also need to be changed.

In order to change the shapes of the picture elements 171R, 171G, and 171B that constitute the pixel contacting the light shielding layer 172, it is necessary to change a shape of an exposure mask used for forming the picture element electrodes and a shape of an exposure mask used for forming the black matrix layers 173R, 173G, and 173B, and therefore, there is a problem that, when the shape of the light shielding layer 172 needs to be changed, design of an active matrix substrate and a color filter substrate needs to be retried.

The invention is made in view of the aforementioned problems and an object thereof is to provide a normally black-type liquid crystal display panel in which design of an active matrix substrate does not need to be retried even when a shape of a light shielding layer that partially covers a display region needs to be changed and which has high productivity, and a method for manufacturing the normally black-type liquid crystal display panel.

### Solution to Problem

In order to solve the aforementioned problems, a normally black-type liquid crystal display panel according to the invention is a normally black-type liquid crystal display panel including a light shielding layer that partially covers an end of a display region, in which a plurality of pixels each including a first picture element, a second picture element, and a third picture element are formed in the display region, each of the first picture element, the second picture element, and the third picture element includes a switching element, and among the plurality of pixels, in at least one or more pixels overlapped with the light shielding layer in plan view, in order for a difference to be small between an area of a light shielding part in any one picture element, which has a largest area covered with the light shielding layer, among the first picture element, the second picture element, and the third picture element and an area of a light shielding part in each of the other two picture elements among the first picture element, the second picture element, and the third picture element, a picture element electrode of each of the other two picture elements is divided into a first picture element electrode connected to a first electrode of the switching element and a second picture element electrode not connected to the first electrode of the switching element.

According to the aforementioned configuration, in order for the difference between the area of the light shielding part in any one picture element which has the largest area covered with the light shielding layer among the first picture element, the second picture element, and the third picture element and the area of the light shielding part in each of the other two picture elements among the first picture element, the second picture element, and the third picture element to be small, the picture element electrode of each of the other two picture elements is divided into the first picture element electrode connected to the first electrode of the switching element and the second picture element electrode not connected to the first electrode of the switching element.

Thus, even when a shape of the light shielding layer that partially covers the display region is changed, a position where the picture element electrode of each of the other two picture elements is divided may be changed, and therefore, the normally black-type liquid crystal display panel in which design of an active matrix substrate does not need to be retried and which has high productivity is able to be implemented.

In order to solve the aforementioned problems, a method for manufacturing a normally black-type liquid crystal display panel according to the invention is a method for manufacturing a normally black-type liquid crystal display panel which includes a light shielding layer that partially covers an end of a display region and in which a plurality of pixels each including a first picture element, a second picture element, and a third picture element are formed in the display region, and the method includes: a step of forming a switching element in each of the first picture element, the second picture element, and the third picture element on one surface of a first substrate; a step of forming a picture element electrode connected to a first electrode of the switching element; a step of forming, on one surface of a second substrate, the light shielding layer and color filter layers which have colors different from each other and are at positions corresponding to the first picture element, the second picture element, and the third picture element; a dividing step of, when the first substrate and the second substrate are arranged so as to face each other, among the plurality of pixels, in at least one or more pixels overlapped with the light shielding layer in plan view, in order for a difference to be small between an area of a light shielding part in any one picture element, which has a largest area covered with the light shielding layer, among the first picture element, the second picture element, and the third picture element and an area of a light shielding part in each of the other two picture elements among the first picture element, the second picture element, and the third picture element, dividing a picture element electrode of each of the other two picture elements into a first picture element electrode connected to the first electrode of the switching element and a second picture element electrode not connected to the first electrode of the switching element; and a step of bonding the one surface of the first substrate where the first picture element electrode and the second picture element electrode are formed and the one surface of the second substrate.

According to the aforementioned method, in order for the difference between the area of the light shielding part in any one picture element which has the largest area covered with the light shielding layer among the first picture element, the second picture element, and the third picture element and the area of the light shielding part in each of the other two picture elements among the first picture element, the second picture element, and the third picture element to be small, the picture element electrode of each of the other two picture elements is divided into the first picture element electrode connected to the first electrode of the switching element and the second picture element electrode not connected to the first electrode of the switching element at the dividing step.

Thus, even when a shape of the light shielding layer that partially covers the display region is changed, a position where the picture element electrode of each of the other two picture elements is divided may be changed, and therefore, a method for manufacturing the normally black-type liquid crystal display panel in which design of an active matrix substrate does not need to be retried and which has high productivity is able to be implemented.

### Advantageous Effects of Invention

According to an aspect of the invention, it is possible to implement a normally black-type liquid crystal display panel in which design of an active matrix substrate does not need to be retried even when a shape of a light shielding layer that partially covers a display region needs to be changed and which has high productivity, and a method for manufacturing the normally black-type liquid crystal display panel.

### BRIEF DESCRIPTION OF DRAWINGS

FIG. 1 illustrates a schematic configuration of a normally black-type liquid crystal display panel.

FIG. 2 is a view illustrating a difference of a light transmitted area between a pixel at an end of a display region of the liquid crystal display panel illustrated in FIG. 1 and a pixel at a center part of the display region.

FIG. 3 is a view for explaining a position where a picture element electrode is divided in the pixel at the end of the display region of the liquid crystal display panel illustrated in FIG. 1.

FIG. 4(a) illustrates a case where a gate driver is provided in a gate driver monolithic form in a region other than the display region of the liquid crystal display panel illustrated in FIG. 1, and FIG. 4(b) illustrates another normally black-type liquid crystal display panel in which gate drivers are provided in a gate driver monolithic form in the display region.

FIG. 5 illustrates an example of a shape of a picture element electrode that is usable for a VA (Vertical Alignment) mode liquid crystal display panel.

FIG. 6 illustrates an example of a shape of a picture element electrode that is usable for an IPS (In-Plane Switching) mode or FFS (Fringe Field Switching) mode liquid crystal display panel.

FIG. 7 illustrates another example of a shape of a picture element electrode that is usable for the IPS (In-Plane Switching) mode or FFS (Fringe Field Switching) mode liquid crystal display panel.

FIG. 8 is a view for explaining a problem of a liquid crystal display panel of the related art with an odd shape that has a display region with an odd shape.

FIG. 9 illustrates a schematic configuration of a liquid crystal display panel with an odd shape that has a display region with an odd shape, which is disclosed in PTL 1.

### DESCRIPTION OF EMBODIMENTS

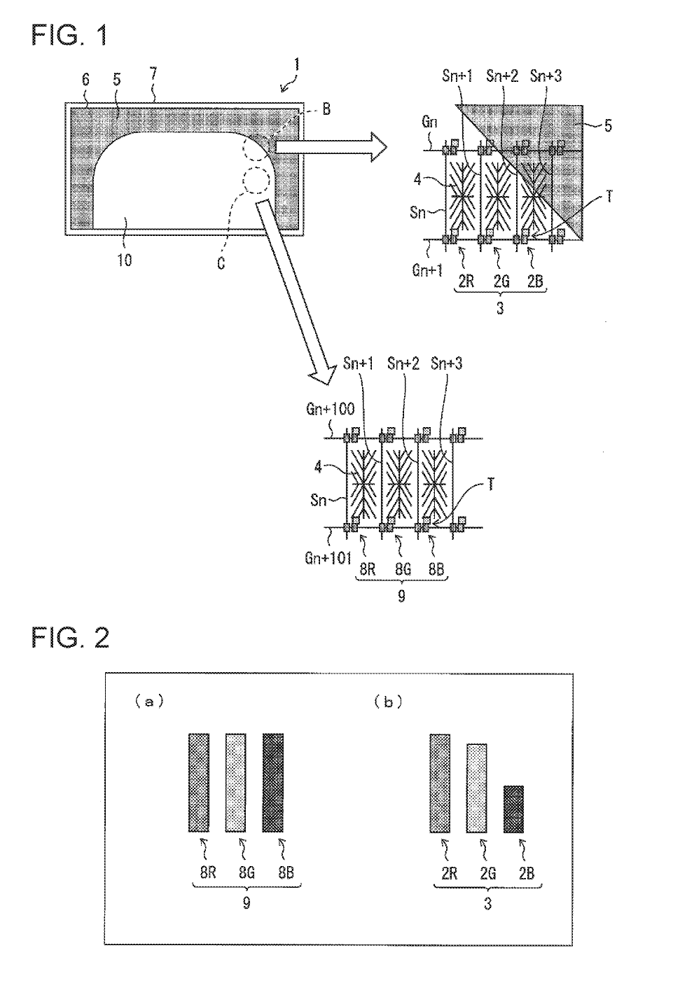

Embodiments of the invention will be described as follows with reference to FIGS. 1 to 7. Hereinafter, for convenience of description, components having the same functions as those described in a specific embodiment will be given the same reference signs and description thereof will be omitted in some cases.

### Embodiment 1

FIG. 1 illustrates a schematic configuration of a normally black-type liquid crystal display panel 1.

As illustrated in the figure, the normally black-type liquid crystal display panel 1 is formed in such a manner that a color filter substrate (second substrate) 6 including a light shielding layer 5 and an active matrix substrate (first substrate) 7 are bonded to each other by a sealing material (not illustrated) or the like.

On one surface of the color filter substrate 6, the light shielding layer 5, and a red color filter layer (not illustrated), a green color filter layer (not illustrated), and a blue color filter layer (not illustrated) which have colors different from each other and are at positions respectively corresponding to a red picture element (first picture element) 2R or 8R, a green picture element (second picture element) 2G or 8G, and a blue picture element (third picture element) 2B or 8B are formed.

On one surface of the active matrix substrate 7, a transistor element (switching element) T and a picture element electrode 4 connected to a drain electrode (first electrode) of the transistor element T are formed in each of the red picture element 2R or 8R, the green picture element 2G or 8G, and the blue picture element 2B or 8B.

A display region of the normally black-type liquid crystal display panel 1 means a region (specifically, a region in which alignment of liquid crystal molecules of a liquid crystal layer is able to be controlled on the basis of a signal input via the drain electrode of the transistor element T) in which a plurality of picture element electrodes 4 each having a fish bone shape and connected to the drain electrode of the transistor element T are formed in a matrix shape on the active matrix substrate 7.

Since a light shielding part that is provided so as to be overlapped with the light shielding layer 5 in plan view and a light shielding part that does not depend on the light shielding layer 5 and is a part of the picture element electrode 4, which is obtained by dividing the picture element electrode 4 at a predetermined place and is not connected to the drain electrode of the transistor element T, are provided in an end of the display region, an effective display region 10 of the normally black-type liquid crystal display panel 1 is a region excluding, from the aforementioned display region, the light shielding part that is provided so as to be overlapped with the light shielding layer 5 in plan view and the light shielding part that does not depend on the light shielding layer 5 and is a part of the picture element electrode 4, which is obtained by dividing the picture element electrode 4 at the predetermined place and is not connected to the drain electrode of the transistor element T.

The display region of the normally black-type liquid crystal display panel 1 before the picture element electrode 4 is divided at the predetermined place includes a plurality of pixels 3 and 9 which are arranged in a matrix shape and respectively include red picture elements 2R and 8R, green picture elements 2G and 8G, and blue picture elements 2B and 8B, and at the end of the display region, the light shielding part that is provided so as to be overlapped with the light shielding layer 5 in plan view and the light shielding part that does not depend on the light shielding layer 5 and is a part of the picture element electrode 4, which is obtained by dividing the picture element electrode 4 at the predetermined place and is not connected to the drain electrode of the transistor element T, are provided.

In the normally black-type liquid crystal display panel 1, shapes of the picture elements 2R, 2G, and 2B that constitute a pixel 3 contacting the light shielding layer 5 are the same as shapes of the picture elements 8R, 8G, and 8B that constitute a pixel 9 not contacting the light shielding layer 5.

In the pixel 3 that is a part B in the normally black-type liquid crystal display panel 1 and contacts the light shielding layer 5, a picture element having a largest area covered with the light shielding layer 5 is the blue picture element 2B, a picture element having a smallest area covered with the light shielding layer 5 is the red picture element 2R, and an area of the green picture element 2G, which is covered with the light shielding layer 5, is larger than that of the red picture element 2R and smaller than that of the blue picture element 2B.

On the other hand, in the pixel 9 that is a part C in the normally black-type liquid crystal display panel 1 and does not contact the light shielding layer 5, none of the red picture element 8R, the green picture element 8G, and the blue picture element 8B are covered with the light shielding layer 5.

Note that, in the active matrix substrate 7 of the normally black-type liquid crystal display panel 1, one corresponding gate wire of a plurality of gate wires Gn to Gn+101 . . . is connected to each of gate electrodes of a plurality of transistor elements T which belong to the same row, one corresponding source wire of a plurality of source wires Sn to Sn+3 . . . is connected to each of source electrodes of a plurality of transistor elements T which belong to the same column, and the picture element electrode 4 is connected to each of drain electrodes of the plurality of transistor elements T.

A signal (scanning signal) that controls a timing when the plurality of transistor elements T which belong to the same row are brought into an active state or an inactive state at the same time is output from a gate driver (not illustrated) to the plurality of gate wires Gn to Gn+101 . . . , and the plurality of transistor elements T which belong to the same row are driven to be brought into the active state for each row, for example.

FIG. 2 is a view illustrating a difference of a light transmitted area between the pixel 9 not contacting the light shielding layer 5 and the pixel 3 contacting the light shielding layer 5 in the normally black-type liquid crystal display panel 1.

As illustrated in FIG. 2(a), in the pixel 9 not contacting the light shielding layer 5, since none of the red picture element 8R, the green picture element 8G, and the blue picture element 8B are covered with the light shielding layer 5, there is no difference of the light transmitted area among the red picture element 8R, the green picture element 8G, and the blue picture element 8B, and thus it is possible to suppress display of a color in which a ratio is different among red, green, and blue in the pixel 9 not contacting the light shielding layer 5.

On the other hand, as illustrated in FIG. 2(b), in the pixel 3 contacting the light shielding layer 5, a picture element having a largest area covered with the light shielding layer 5 is the blue picture element 2B, a picture element having a smallest area covered with the light shielding layer 5 is the red picture element 2R, and an area of the green picture element 2G, which is covered with the light shielding layer 5, is larger than that of the red picture element 2R and smaller than that of the blue picture element 2B. That is, light transmitted areas of the red picture element 2R, the green picture element 2G, and the blue picture element 2B are different and have a relation of the light transmitted area of the red picture element 2R>the light transmitted area of the green picture element 2G>the light transmitted area of the blue picture element 2B.

Accordingly, since the pixel 3 contacting the light shielding layer 5 displays a color in which the ratio is different among red, green, and blue, there is a problem that a hue is different between the pixel 3 contacting the light shielding layer 5 and the pixel 9 not contacting the light shielding layer 5.

Thus, in the normally black-type liquid crystal display panel 1, by dividing, at the predetermined place, the picture element electrode 4 in the pixel 3 contacting the light shielding layer 5, such a problem is addressed.

In the present embodiment, a laser peeling apparatus is used for dividing (cutting) the picture element electrode 4 at the predetermined place, and laser light of the laser peeling apparatus is used which has a wavelength in an ultraviolet region (for example, wavelength of 266 nm) suitable for peeling off a transparent electrode layer that is a general material used for forming the picture element electrode 4, but a type of the peeling apparatus is not limited to the laser peeling apparatus.

The description has been given by taking the case where the laser peeling apparatus is used for dividing (cutting) the picture element electrode 4 at the predetermined place as an example in the present embodiment, but there is no limitation thereto and the picture element electrode 4 may be divided (cut) at the predetermined place at the same time with patterning of the picture element electrode 4 into a predetermined shape. For example, the picture element electrode 4 connected to the drain electrode of the transistor element T and the picture element electrode 4 not connected to the drain electrode of the transistor element T may be formed by using a resist film having a predetermined pattern that is formed on a layer (a layer on which the picture element electrode 4 that is not subjected to patterning is to be formed) on which the picture element electrode 4 is to be formed and performing patterning of the layer, on which the picture element electrode 4 is to be formed, for example, by dry etching or wet etching.

Further, since a picture element electrode having a fish bone shape is used as the picture element electrode 4 in the present embodiment, the picture element electrode 4 is able to be easily divided.

Note that, when the picture element electrode 4 is divided at the predetermined place by using the laser peeling apparatus or the like, for example, the division is preferably performed immediately after the picture element electrode 4 is formed, from a viewpoint of suppressing generation of a misaligned region of liquid crystal.

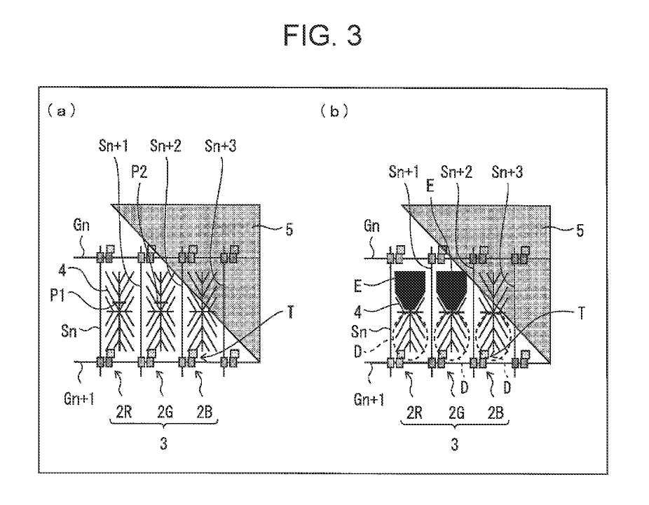

FIG. 3(a) is a view for explaining a position where the picture element electrode 4 is divided in the pixel 3 contacting the light shielding layer 5 in the normally black-type liquid crystal display panel 1, and FIG. 3(b) is a view for explaining that display of a color in which the ratio is different among red, green, and blue is able to be suppressed by dividing the picture element electrode 4 in the pixel 3 contacting the light shielding layer 5.

As illustrated in FIG. 3(a), in the pixel 3 contacting the light shielding layer 5, in order for a difference between an area of a light shielding part in the blue picture element 2B having the largest area covered with the light shielding layer 5 and an area of a light shielding part in each of the red picture element 2R and the green picture element 2G to be small, the picture element electrode 4 in each of the red picture element 2R and the green picture element 2G is divided into a first picture element electrode (a picture element electrode on a lower side of a dividing line P1 or P2 in FIG. 3(a)) connected to the drain electrode of the transistor element T and a second picture element electrode (a picture element electrode on an upper side of the dividing line P1 or P2 in FIG. 3(a)) not connected to the drain electrode of the transistor element T.

That is, the light shielding part in the blue picture element 2B is formed by the light shielding layer 5, the light shielding part in the green picture element 2G is formed by the light shielding layer 5 and the light shielding part that is a part of the picture element electrode 4 not connected to the drain electrode of the transistor element T and does not depend on the light shielding layer 5, and the light shielding part in the red picture element 2R is formed by the light shielding part that is a part of the picture element electrode 4 not connected to the drain electrode of the transistor element T and does not depend on the light shielding layer 5.

In the present embodiment, in order for the area of the light shielding part in the blue picture element 2B having the largest area covered with the light shielding layer 5 and the area of the light shielding part in each of the red picture element 2R and the green picture element 2G to be substantially equal to each other, the picture element electrode 4 in the red picture element 2R is divided along the dividing line P1 into the first picture element electrode connected to the drain electrode of the transistor element T and the second picture element electrode not connected to the drain electrode of the transistor element T, and the picture element electrode 4 in the green picture element 2G is divided along the dividing line P2 into the first picture element electrode connected to the drain electrode of the transistor element T and the second picture element electrode not connected to the drain electrode of the transistor element T, however, there is no limitation thereto as long as the division is performed such that the difference between the area of the light shielding part in the blue picture element 2B having the largest area covered with the light shielding layer 5 and the area of the light shielding part in each of the red picture element 2R and the green picture element 2G is small.

A reason for making a position of the dividing line P1 in the red picture element 2R and a position of the dividing line P2 in the green picture element 2G substantially equal to each other is that the transmitted area in the red picture element 2R and the transmitted area in the green picture element 2G are made equal to the transmitted area in the blue picture element 2B having the largest area of the light shielding part.

In the present embodiment, since the light shielding part formed by the light shielding layer 5 in the green picture element 2G is included in the light shielding part formed by the light shielding part that is a part of the picture element electrode 4 not connected to the drain electrode of the transistor element T and does not depend on the light shielding layer 5, the position of the dividing line P1 in the red picture element 2R and the position of the dividing line P2 in the green picture element 2G are made substantially equal to each other, however, there is no limitation thereto and the position of the dividing line P1 in the red picture element 2R and the position of the dividing line P2 in the green picture element 2G may be different from each other.

As illustrated in FIG. 3(b), the picture element electrode 4 in the red picture element 2R is divided along the dividing line P1 into the first picture element electrode connected to the drain electrode of the transistor element T and the second picture element electrode not connected to the drain electrode of the transistor element T, and the liquid crystal display panel 1 has a normally black type, so that the first picture element electrode connected to the drain electrode of the transistor element T is a light transmitted area D and the second picture element electrode not connected to the drain electrode of the transistor element T is an area E of the light shielding part.

Similarly, the picture element electrode 4 in the green picture element 2G is divided along the dividing line P2 into the first picture element electrode connected to the drain electrode of the transistor element T and the second picture element electrode not connected to the drain electrode of the transistor element T, and the liquid crystal display panel 1 has the normally black type, so that the first picture element electrode connected to the drain electrode of the transistor element T is the light transmitted area D and the second picture element electrode not connected to the drain electrode of the transistor element T is the area E of the light shielding part.

As described above, when the picture element electrode 4 in each of the red picture element 2R and the green picture element 2G is divided, the light transmitted area D of the red picture element 2R, the light transmitted area D of the green picture element 2G, and the light transmitted area D of the blue picture element 2B are substantially equal to each other as illustrated in FIG. 3(b), thus making it possible to suppress display of a color in which the ratio is different among red, green, and blue in the pixel 3 contacting the light shielding layer 5.

Though the present embodiment has been described by taking the case where the shapes of the picture elements 2R, 2G, and 2B that constitute the pixel 3 contacting the light shielding layer 5 and the shapes of the picture elements 8R, 8G, and 8B that constitute the pixel 9 not contacting the light shielding layer 5 are formed into the same shapes as an example, the shapes of the picture elements 2R, 2G, and 2B that constitute the pixel 3 contacting the light shielding layer 5 and the shapes of the picture elements 8R, 8G, and 8B that constitute the pixel 9 not contacting the light shielding layer 5 may be different from each other.

Moreover, though the present embodiment has been described by taking the case where a single pixel is constituted by three picture elements as an example, there is no limitation thereto and the single pixel may be constituted by four or more picture elements.

Moreover, though the present embodiment has been described by taking the transistor element (TFT element) as an example of the switching element, there is no limitation thereto and a diode element (MIM element) or the like may be used as the switching element, for example.

Moreover, though the division of the picture element electrode 4 is performed in all pixels 3 contacting the light shielding layer 5 in the liquid crystal display panel 1 in the present embodiment, there is no limitation thereto and the division of the picture element electrode 4 may be performed only in a part of the pixels 3 contacting the light shielding layer 5, for example, a pixel in which a difference of light transmitted areas is a certain value or more.

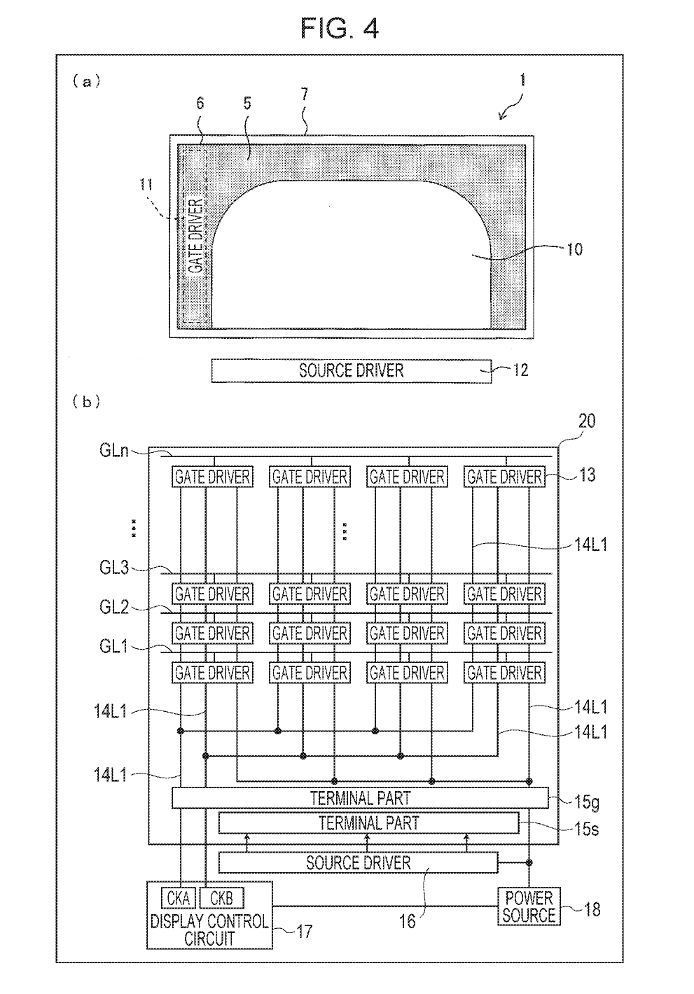

FIG. 4(a) illustrates a case where a gate driver 11 is provided in a gate driver monolithic (GDM) form in a region other than the display region of the liquid crystal display panel 1 and FIG. 4(b) illustrates an example of an active matrix substrate 20 on which gate drivers 13 are provided in a gate driver monolithic form in the display region.

As illustrated in FIG. 4(a), in the normally black-type liquid crystal display panel 1, the gate driver 11 is provided in the gate driver monolithic form in the region other than the display region of the liquid crystal display panel 1, and a source driver 12 and the like are externally connected.

As described above, by providing the gate driver 11 in the gate driver monolithic form in the region other than the display region of the liquid crystal display panel 1, the normally black-type liquid crystal display panel 1 is able to be narrowed.

Note that, a method for providing the gate driver in the gate driver monolithic form is not limited to a method for providing the gate driver in the gate driver monolithic form in the region other than the display region of the liquid crystal display panel as illustrated in FIG. 4(a), and the gate driver may be provided in the gate driver monolithic form in the display region of the liquid crystal display panel as illustrated in FIG. 4(b).

As illustrated in FIG. 4(b), gate wires GL1, . . . , and GLn, source wires (not illustrated), the gate drivers 13, and two terminal parts 15g and 15s are formed in the active matrix substrate 20.

The gate drivers 13 that output scanning signals to the gate wires GL1, . . . , and GLn are formed in the display region, a source driver 16, a display control circuit 17, and a power source 18 are externally connected, and a control signal is supplied from the display control circuit 17 to each of the gate drivers 13 via a wire 14L1.

As described above, by providing the gate drivers 13 in the gate driver monolithic form in the display region, the normally black-type liquid crystal display panel is able to be further narrowed.

### Embodiment 2

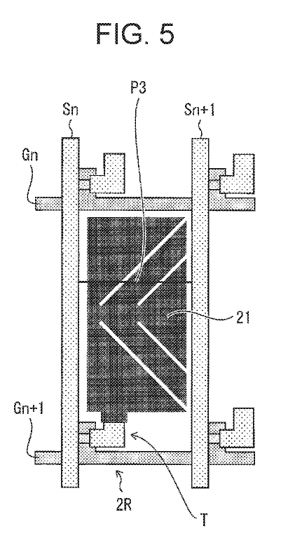

Next, Embodiment 2 of the invention will be described with reference to FIG. 5. The present embodiment is different from Embodiment 1 in terms of using a picture element electrode 21 that is usable for a VA (Vertical Alignment) mode liquid crystal display panel and the other points are as described in Embodiment 1. For convenience of description, members having the same functions as those of the members illustrated in the figures of Embodiment 1 will be given the same reference signs and description thereof will be omitted.

FIG. 5 illustrates a shape of the picture element electrode 21 that is usable for the VA mode liquid crystal display panel.

As illustrated in the figure, the picture element electrode 21 is an electrode obtained by forming a plurality of slits obliquely in an electrode formed in a flush manner and is able to be divided, for example, along a dividing line P3, into a first picture element electrode (picture element electrode on a lower side of the dividing line P3) connected to the drain electrode of the transistor element T and a second picture element electrode (picture element electrode on an upper side of the dividing line P3) not connected to the drain electrode of the transistor element T. Note that, a part of the second picture element electrode (picture element electrode on the upper side of the dividing line P3) not connected to the drain electrode of the transistor element T is a light shielding part that does not depend on the light shielding layer 5.

As described above, by dividing the picture element electrode 21, the VA mode liquid crystal display panel is also able to suppress display of a color in which the ratio is different among red, green, and blue in the pixel 3 contacting the light shielding layer 5, similarly to Embodiment 1 described above.

### Embodiment 3

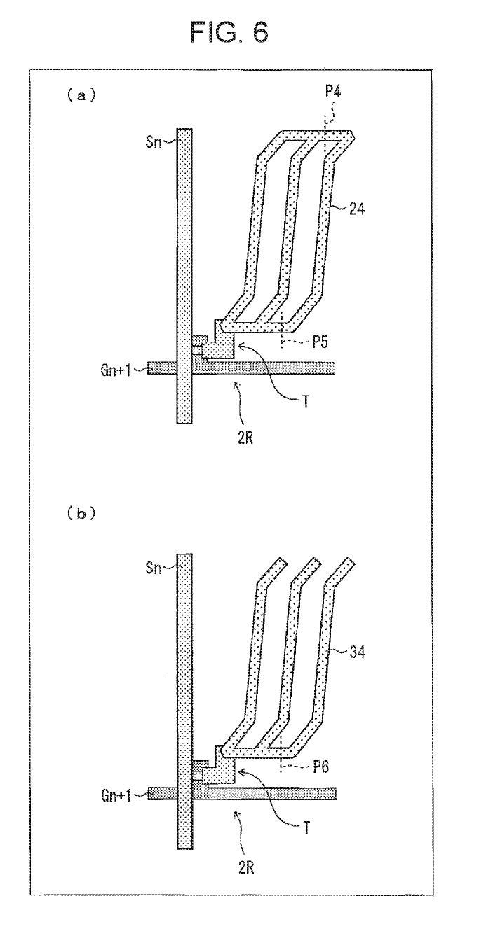

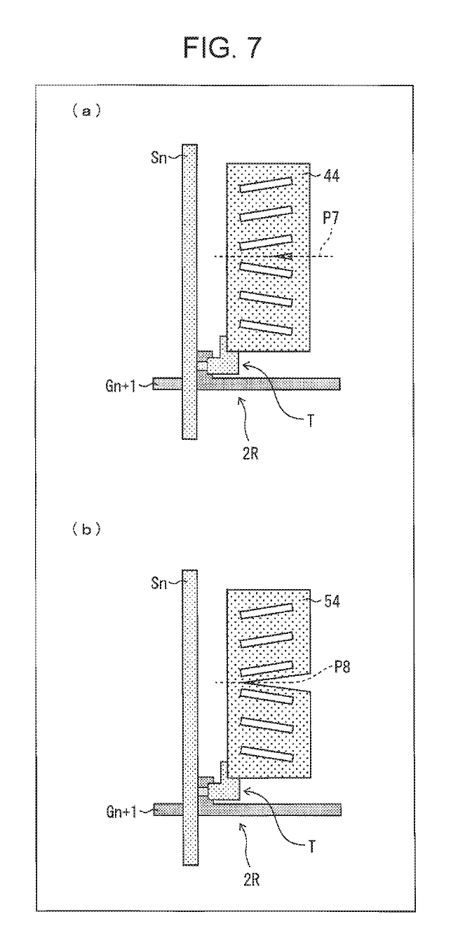

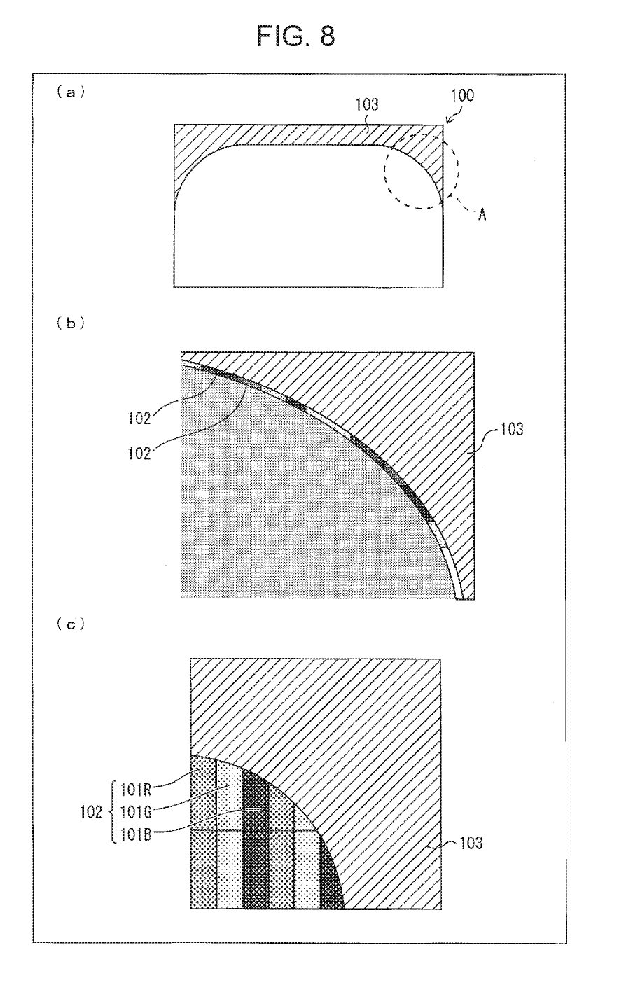

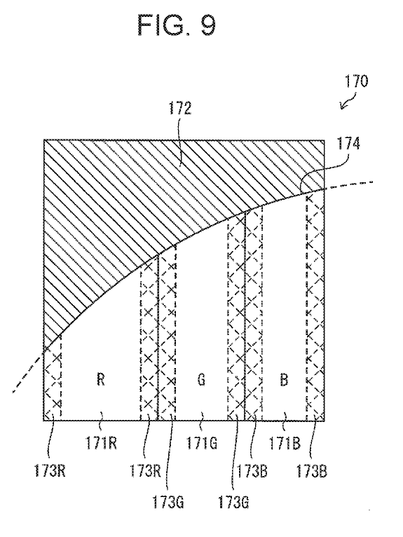

Next, Embodiment 3 of the invention will be described with reference to FIGS. 6 and 7. The present embodiment is different from Embodiments 1 and 2 in terms of using picture element electrodes 24, 34, 44, and 54 that are usable for an IPS (In-Plane Switching) mode or FFS (Fringe Field Switching) mode liquid crystal display panel and the other points are as described in Embodiments 1 and 2. For convenience of description, members having the same functions as those of the members illustrated in the figures of Embodiments 1 and 2 will be given the same reference signs and description thereof will be omitted.

FIG. 6 illustrates the picture element electrodes 24 and 34 that are usable for the IPS mode or FFS mode liquid crystal display panel.

The picture element electrode 24 illustrated in FIG. 6(a) is an electrode having a shape in which two bridge parts (connecting parts) that connect three comb tooth parts are provided in an upper side and a lower side, and, in order to divide the rightmost comb tooth part, division needs to be performed along a dividing line P4 and a dividing line P5 in the two bridge parts.

On the other hand, the picture element electrode 34 illustrated in FIG. 6(b) is an electrode having a shape in which one bridge part (connecting part) that connects three comb tooth parts is provided only on a lower side, and, in order to divide the rightmost comb tooth part, division may be performed along a dividing line P6 in the bridge part on the lower side.

Thus, from a viewpoint of easily performing division of the picture element electrode, the picture element electrode 34 illustrated in FIG. 6(b) is more preferably used than the picture element electrode 24 illustrated in FIG. 6(a).

Note that, a width of each of the bridge parts (connecting parts) illustrated in FIG. 6(a) in a direction in which the picture element electrode 24 is divided, that is, in a vertical direction in FIG. 6(a) is narrower than a width in a vertical direction of a first picture element electrode that is the picture element electrode 24 on a left side of the dividing line P4 and the dividing line P5 and is connected to the drain electrode of the transistor element T and a width in a vertical direction of a second picture element electrode that is the picture element electrode 24 on a right side of the dividing line P4 and the dividing line P5 and is not connected to the drain electrode of the transistor element T.

A width of the bridge part (connecting part) illustrated in FIG. 6(b) in a direction in which the picture element electrode 34 is divided, that is, in a vertical direction in FIG. 6(b) is also narrower than a width in a vertical direction of a first picture element electrode that is the picture element electrode 34 on a left side of the dividing line P6 and is connected to the drain electrode of the transistor element T and a width in a vertical direction of a second picture element electrode that is the picture element electrode 34 on a right side of the dividing line P6 and is not connected to the drain electrode of the transistor element T.

Thus, the division of the picture element electrodes 24 and 34 is preferably performed in the bridge part (connecting part).

FIG. 7 illustrates the picture element electrodes 44 and 54 that are usable for the IPS mode or FFS mode liquid crystal display panel.

FIG. 7(a) illustrates the picture element electrode 44 that does not have a bridge part (connecting part) and FIG. 7(b) illustrates the picture element electrode 54 that has a bridge part (connecting part).

A width of the bridge part (connecting part) illustrated in FIG. 7(b) in a direction in which the picture element electrode 54 is divided, that is, in a horizontal direction in FIG. 7(b) is narrower than a width in a horizontal direction of a first picture element electrode that is the picture element electrode 54 on a lower side of a dividing line P8 and is connected to the drain electrode of the transistor element T and a width in a horizontal direction of a second picture element electrode that is the picture element electrode 54 on an upper side of the dividing line P8 and is not connected to the drain electrode of the transistor element T.

Thus, from a viewpoint of easily performing division of the picture element electrode, the picture element electrode 54 that has the bridge part (connecting part) illustrated in FIG. 7(b) is more preferably used than the picture element electrode 44 that does not have a bridge part (connecting part) illustrated in FIG. 7(a).

### (Method for Manufacturing Normally Black-Type Liquid Crystal Display Panel)

A method for manufacturing the normally black-type liquid crystal display panel 1 which includes the light shielding layer 5 that partially covers an end of a display region and in which a plurality of pixels 3 and 9 respectively including the red picture elements 2R and 8R, the green picture elements 2G and 8G, and the blue picture elements 2B and 8B are formed in the display region will be described below with reference to FIGS. 1, 3, and 4.

The method for manufacturing the normally black-type liquid crystal display panel 1 includes: a step of forming the transistor element (switching element) T in each of the red picture element 2R or 8R, the green picture element 2G or 8G, and the blue picture element 2B or 8B on one surface of the active matrix substrate 7; a step of forming the picture element electrode 4 connected to the drain electrode (first electrode) of the transistor element T; a step of forming, on one surface of the color filter substrate 6, the light shielding layer 5, and a red color filter layer (not illustrated), a green color filter layer (not illustrated), and a blue color filter layer (not illustrated) that are color filter layers which have colors different from each other and which are at positions respectively corresponding to the red picture element (first picture element) 2R or 8R, the green picture element (second picture element) 2G or 8G, and the blue picture element (third picture element) 2B or 8B; a dividing step of, when the color filter substrate 6 and the active matrix substrate 7 are arranged so as to face each other, among the plurality of pixels 3 and 9, in at least one or more pixels of the pixels 3 overlapped with the light shielding layer 5 in plan view, in order for a difference between an area of a light shielding part in the blue picture element 2B which has a largest area covered with the light shielding layer 5 and an area of a light shielding part in each of the red picture element 2R and the green picture element 2G to be small, dividing the picture element electrode 4 of each of the red picture element 2R and the green picture element 2G into a first picture element electrode connected to the drain electrode (first electrode) of the transistor element (switching element) T and a second picture element electrode not connected to the drain electrode (first electrode) of the transistor element (switching element) T; and a step of bonding the one surface of the active matrix substrate 7 where the first picture element electrode and the second picture element electrode are formed and the one surface of the color filter substrate 6.

It is preferable that, at the dividing step, in order for the area of the light shielding part in the blue picture element 2B which has the largest area covered with the light shielding layer 5 and the area of the light shielding part in each of the red picture element 2R and the green picture element 2G to be equal to each other, the second picture element electrode is formed in each of the red picture element 2R and the green picture element 2G.

It is preferable that the dividing step is performed immediately after the step of forming the picture element electrode 4 connected to the drain electrode (first electrode) of the transistor element (switching element) T.

It is preferable that the picture element electrode 4 is divided by using laser light at the dividing step.

At the step of forming the transistor element (switching element) T, the gate driver (driving circuit) 11 that controls a timing when the transistor element T is brought into an active state or an inactive state may be formed in the active matrix substrate 7.

Note that, the gate driver (driving circuit) 11 may be provided in a region other than the display region of the active matrix substrate 7 or may be provided in the display region of the active matrix substrate 7.

Before the step of bonding the one surface of the active matrix substrate 7 and the one surface of the color filter substrate 6, a liquid crystal layer may be formed by a liquid crystal dropping method on at least any one of the one surface of the active matrix substrate 7 and the one surface of the color filter substrate 6.

Further, at the step of bonding the one surface of the active matrix substrate 7 and the one surface of the color filter substrate 6, a liquid crystal filling port may be formed by using a sealing material and the one surface of the active matrix substrate 7 and the one surface of the color filter substrate 6 may be bonded, and after the bonding step, between the one surface of the active matrix substrate 7 and the one surface of the color filter substrate 6 which are bonded to each other, liquid crystal may be filled via the liquid crystal filling port.

### CONCLUSION

A normally black-type liquid crystal display panel according to an aspect 1 of the invention is a normally black-type liquid crystal display panel including a light shielding layer that partially covers an end of a display region, in which a plurality of pixels each including a first picture element, a second picture element, and a third picture element are formed in the display region, each of the first picture element, the second picture element, and the third picture element includes a switching element, and among the plurality of pixels, in at least one or more pixels overlapped with the light shielding layer in plan view, in order for a difference to be small between an area of a light shielding part in any one picture element, which has a largest area covered with the light shielding layer, among the first picture element, the second picture element, and the third picture element and an area of a light shielding part in each of the other two picture elements among the first picture element, the second picture element, and the third picture element, a picture element electrode of each of the other two picture elements is divided into a first picture element electrode connected to a first electrode of the switching element and a second picture element electrode not connected to the first electrode of the switching element.

According to the aforementioned configuration, in order for the difference between the area of the light shielding part in any one picture element which has the largest area covered with the light shielding layer among the first picture element, the second picture element, and the third picture element and the area of the light shielding part in each of the other two picture elements among the first picture element, the second picture element, and the third picture element to be small, the picture element electrode of each of the other two picture elements is divided into the first picture element electrode connected to the first electrode of the switching element and the second picture element electrode not connected to the first electrode of the switching element.

Thus, even when a shape of the light shielding layer that partially covers the display region is changed, a position where the picture element electrode of each of the other two picture elements is divided may be changed, so that the normally black-type liquid crystal display panel in which design of an active matrix substrate does not need to be retried and which has high productivity is able to be implemented.

In the normally black-type liquid crystal display panel according to an aspect 2 of the invention, it is preferable that, in order for the area of the light shielding part in any one picture element which has the largest area covered with the light shielding layer among the first picture element, the second picture element, and the third picture element and the area of the light shielding part in each of the other two picture elements among the first picture element, the second picture element, and the third picture element to be equal to each other, the second picture element electrode is formed in each of the other two picture elements, in the aspect 1.

According to the aforementioned configuration, it is possible to further suppress display of a color in which the ratio is different.

The normally black-type liquid crystal display panel according to an aspect 3 of the invention further includes a driving circuit that controls a timing when the switching element is brought into an active state or an inactive state, in the aspect 1 or 2.

According to the aforementioned configuration, it is possible to implement the normally black-type liquid crystal display panel including the driving circuit.

In the normally black-type liquid crystal display panel according to an aspect 4 of the invention, it is preferable that a first substrate includes the switching element and the picture element electrode, and the driving circuit is provided in a region other than the display region on a surface of the first substrate where the switching element and the picture element electrode are provided, in the aspect 3.

According to the aforementioned configuration, it is possible to achieve narrowing of the normally black-type liquid crystal display panel.

In the normally black-type liquid crystal display panel according to an aspect 5 of the invention, it is preferable that a first substrate includes the switching element and the picture element electrode, and the driving circuit is provided in the display region on a surface of the first substrate where the switching element and the picture element electrode are provided, in the aspect 3.

According to the aforementioned configuration, it is possible to achieve further narrowing of the normally black-type liquid crystal display panel.

In the normally black-type liquid crystal display panel according to an aspect 6 of the invention, it is preferable that the picture element electrode includes the first picture element electrode, the second picture element electrode, and a connecting part that connects the first picture element electrode and the second picture element electrode, a width of the connecting part in a direction in which the picture element electrode is divided into the first picture element electrode and the second picture element electrode is narrower than widths of the first picture element electrode and the second picture element electrode, and the picture element electrode is divided in the connecting part, in any of the aspects 1 to 5.

According to the aforementioned configuration, it is possible to easily divide the picture element electrode.

In the normally black-type liquid crystal display panel according to an aspect 7 of the invention, it is preferable that the connecting part is one connecting part provided in the picture element electrode in the aspect 6.

According to the aforementioned configuration, it is possible to further easily divide the picture element electrode.

In order to solve the aforementioned problems, a method for manufacturing a normally black-type liquid crystal display panel according to an aspect 8 of the invention is a method for manufacturing a normally black-type liquid crystal display panel which includes a light shielding layer that partially covers an end of a display region and in which a plurality of pixels each including a first picture element, a second picture element, and a third picture element are formed in the display region, and the method includes: a step of forming a switching element in each of the first picture element, the second picture element, and the third picture element on one surface of a first substrate; a step of forming a picture element electrode connected to a first electrode of the switching element; a step of forming, on one surface of a second substrate, the light shielding layer and color filter layers which have colors different from each other and are at positions corresponding to the first picture element, the second picture element, and the third picture element; a dividing step of, when the first substrate and the second substrate are arranged so as to face each other, among the plurality of pixels, in at least one or more pixels overlapped with the light shielding layer in plan view, in order for a difference to be small between an area of a light shielding part in any one picture element, which has a largest area covered with the light shielding layer, among the first picture element, the second picture element, and the third picture element and an area of a light shielding part in each of the other two picture elements among the first picture element, the second picture element, and the third picture element, dividing a picture element electrode of each of the other two picture elements into a first picture element electrode connected to the first electrode of the switching element and a second picture element electrode not connected to the first electrode of the switching element; and a step of bonding the one surface of the first substrate where the first picture element electrode and the second picture element electrode are formed and the one surface of the second substrate.

According to the aforementioned method, in order for the difference between the area of the light shielding part in any one picture element which has the largest area covered with the light shielding layer among the first picture element, the second picture element, and the third picture element and the area of the light shielding part in each of the other two picture elements among the first picture element, the second picture element, and the third picture element to be small, the picture element electrode of each of the other two picture elements is divided into the first picture element electrode connected to the first electrode of the switching element and the second picture element electrode not connected to the first electrode of the switching element at the dividing step.

Thus, even when a shape of the light shielding layer that partially covers the display region is changed, a position where the picture element electrode of each of the other two picture elements is divided may be changed, so that the normally black-type liquid crystal display panel in which design of an active matrix substrate does not need to be retried and which has high productivity is able to be implemented.

In the method for manufacturing the normally black-type liquid crystal display panel according to an aspect 9 of the invention, it is preferable that, at the dividing step, in order for the area of the light shielding part in any one picture element, which has the largest area covered with the light shielding layer, among the first picture element, the second picture element, and the third picture element and the area of the light shielding part in each of the other two picture elements among the first picture element, the second picture element, and the third picture element to be equal to each other, the second picture element electrode is formed in each of the other two picture elements, in the aspect 8.

According to the aforementioned method, it is possible to further suppress display of a color in which the ratio is different.

In the method for manufacturing the normally black-type liquid crystal display panel according to an aspect 10 of the invention, it is preferable that the dividing step is performed immediately after the step of forming the picture element electrode connected to the first electrode of the switching element, in the aspect 8 or 9.

According to the aforementioned method, it is possible to suppress generation of a misaligned region of liquid crystal.

In the method for manufacturing the normally black-type liquid crystal display panel according to an aspect 11 of the invention, it is preferable that the picture element electrode is divided by using laser light at the dividing step in any of the aspects 8 to 10.

According to the aforementioned method, it is possible to easily divide the picture element electrode.

In the method for manufacturing the normally black-type liquid crystal display panel according to an aspect 12 of the invention, the step of forming the picture element electrode connected to the first electrode of the switching element may include a step of forming the picture element electrode into a predetermined shape by using a resist film having a predetermined pattern formed on a layer on which the picture element electrode is to be formed and performing patterning of the layer on which the picture element electrode is to be formed, the step of forming the picture element electrode into the predetermined shape and the dividing step may be one step, and by using the resist film having the predetermined pattern formed on the layer on which the picture element electrode is to be formed and performing patterning of the layer on which the picture element electrode is to be formed, the first picture element electrode connected to the first electrode of the switching element and the second picture element electrode not connected to the first electrode of the switching element may be formed, in the aspect 8 or 9.

According to the aforementioned method, since the step of forming the picture element electrode into the predetermined shape and the dividing step are performed by one step, it is possible to reduce the number of manufacturing steps.

In the method for manufacturing the normally black-type liquid crystal display panel according to an aspect 13 of the invention, it is preferable that, at the step of forming the switching element, a driving circuit that controls a timing when the switching element is brought into an active state or an inactive state is formed on the first substrate, in any of the aspects 8 to 12.

According to the aforementioned method, it is possible to implement the normally black-type liquid crystal display panel including the driving circuit.

In the method for manufacturing the normally black-type liquid crystal display panel according to an aspect 14 of the invention, it is preferable that the driving circuit is provided in a region other than the display region of the first substrate in the aspect 13.

According to the aforementioned method, it is possible to achieve narrowing of the normally black-type liquid crystal display panel.

In the method for manufacturing the normally black-type liquid crystal display panel according to an aspect 15 of the invention, it is preferable that the driving circuit is provided in the display region of the first substrate in the aspect 13.

According to the aforementioned configuration, it is possible to achieve further narrowing of the normally black-type liquid crystal display panel.

In the method for manufacturing the normally black-type liquid crystal display panel according to an aspect 16 of the invention, it is preferable that, before the step of bonding the one surface of the first substrate where the first picture element electrode and the second picture element electrode are formed and the one surface of the second substrate, a liquid crystal layer is formed by a liquid crystal dropping method on at least any one of the one surface of the first substrate and the one surface of the second substrate, in any of the aspects 8 to 15.

According to the aforementioned method, it is possible to implement the normally black-type liquid crystal display panel in which the liquid crystal layer is formed by the liquid crystal dropping method.

In the method for manufacturing the normally black-type liquid crystal display panel according to an aspect 17 of the invention, at the step of bonding the one surface of the first substrate where the first picture element electrode and the second picture element electrode are formed and the one surface of the second substrate, a liquid crystal filling port may be formed by using a sealing material and the one surface of the first substrate and the one surface of the second substrate may be bonded, and after the step of bonding the one surface of the first substrate where the first picture element electrode and the second picture element electrode are formed and the one surface of the second substrate, between the one surface of the first substrate and the one surface of the second substrate which are bonded to each other, liquid crystal may be filled via the liquid crystal filling port, in any of the aspects 8 to 15.

According to the aforementioned method, it is possible to implement the normally black-type liquid crystal display panel in which the liquid crystal layer is formed by the liquid crystal dropping method.

### [Additional Matter]

The invention is not limited to each of the embodiments described above, and may be modified in various manners within the scope indicated in the claims and an embodiment achieved by appropriately combining technical means disclosed in each of different embodiments is also encompassed in the technical scope of the invention. Further, by combining the technical means disclosed in each of the embodiments, a new technical feature may be formed.

### INDUSTRIAL APPLICABILITY

The invention is able to be used for a liquid crystal display panel and a method for manufacturing the liquid crystal display panel.

### REFERENCE SIGNS LIST

1 normally black-type liquid crystal display panel
2R red picture element (picture element)
2G green picture element (picture element)
2B blue picture element (picture element)
3 pixel
4 picture element electrode
5 light shielding layer
6 color filter substrate (second substrate)
7 active matrix substrate (first substrate)
8R red picture element (picture element)
8G green picture element (picture element)
8B blue picture element (picture element)
9 pixel
11 gate driver (driving circuit)
13 gate driver (driving circuit)
20 active matrix substrate (first substrate)
21 picture element electrode
24 picture element electrode
34 picture element electrode
44 picture element electrode
54 picture element electrode
T transistor element (switching element)

1. A normally black-type liquid crystal display panel comprising a light shielding layer that partially covers an end of a display region, wherein
a plurality of pixels each including a first picture element, a second picture element, and a third picture element are formed in the display region,
each of the first picture element, the second picture element, and the third picture element includes a switching element, and
among the plurality of pixels, in at least one or more pixels overlapped with the light shielding layer in plan view, in order for a difference to be small between an area of a light shielding part in any one picture element, which has a largest area covered with the light shielding layer, among the first picture element, the second picture element, and the third picture element and an area of a light shielding part in each of the other two picture elements among the first picture element, the second picture element, and the third picture element, a picture element electrode of each of the other two picture elements is divided into a first picture element electrode connected to a first electrode of the switching element and a second picture element electrode not connected to the first electrode of the switching element.

2. The normally black-type liquid crystal display panel according to claim 1, wherein, in order for the area of the light shielding part in any one picture element which has the largest area covered with the light shielding layer among the first picture element, the second picture element, and the third picture element and the area of the light shielding part in each of the other two picture elements among the first picture element, the second picture element, and the third picture element to be equal to each other, the second picture element electrode is formed in each of the other two picture elements.

3. The normally black-type liquid crystal display panel according to claim 1, further comprising a driving circuit that controls a timing when the switching element is brought into an active state or an inactive state.

4. The normally black-type liquid crystal display panel according to claim 3, wherein
a first substrate includes the switching element and the picture element electrode, and
the driving circuit is provided in a region other than the display region on a surface of the first substrate where the switching element and the picture element electrode are provided.

5. The normally black-type liquid crystal display panel according to claim 3, wherein
a first substrate includes the switching element and the picture element electrode, and
the driving circuit is provided in the display region on a surface of the first substrate where the switching element and the picture element electrode are provided.

6. The normally black-type liquid crystal display panel according to claim 1, wherein
the picture element electrode includes the first picture element electrode, the second picture element electrode, and a connecting part that connects the first picture element electrode and the second picture element electrode,
a width of the connecting part in a direction in which the picture element electrode is divided into the first picture element electrode and the second picture element electrode is narrower than widths of the first picture element electrode and the second picture element electrode, and
the picture element electrode is divided in the connecting part.

7. The normally black-type liquid crystal display panel according to claim 6, wherein the connecting part is one connecting part provided in the picture element electrode.

8. A method for manufacturing a normally black-type liquid crystal display panel which includes a light shielding layer that partially covers an end of a display region and in which a plurality of pixels each including a first picture element, a second picture element, and a third picture element are formed in the display region, the method comprising:
a step of forming a switching element in each of the first picture element, the second picture element, and the third picture element on one surface of a first substrate;
a step of forming a picture element electrode connected to a first electrode of the switching element;
a step of forming, on one surface of a second substrate, the light shielding layer and color filter layers which have colors different from each other and are at positions corresponding to the first picture element, the second picture element, and the third picture element;
a dividing step of, when the first substrate and the second substrate are arranged so as to face each other, among the plurality of pixels, in at least one or more pixels overlapped with the light shielding layer in plan view, in order for a difference to be small between an area of a light shielding part in any one picture element, which has a largest area covered with the light shielding layer, among the first picture element, the second picture element, and the third picture element and an area of a light shielding part in each of the other two picture elements among the first picture element, the second picture element, and the third picture element, dividing a picture element electrode of each of the other two picture elements into a first picture element electrode connected to the first electrode of the switching element and a second picture element electrode not connected to the first electrode of the switching element; and
a step of bonding the one surface of the first substrate where the first picture element electrode and the second picture element electrode are formed and the one surface of the second substrate.

9. The method for manufacturing the normally black-type liquid crystal display panel according to claim 8, wherein, at the dividing step, in order for the area of the light shielding part in any one picture element, which has the largest area covered with the light shielding layer, among the first picture element, the second picture element, and the third picture element and the area of the light shielding part in each of the other two picture elements among the first picture element, the second picture element, and the third picture element to be equal to each other, the second picture element electrode is formed in each of the other two picture elements.

10. The method for manufacturing the normally black-type liquid crystal display panel according to claim 8, wherein the dividing step is performed immediately after the step of forming the picture element electrode connected to the first electrode of the switching element.

11. The method for manufacturing the normally black-type liquid crystal display panel according to claim 8, wherein the picture element electrode is divided by using laser light at the dividing step.

12. The method for manufacturing the normally black-type liquid crystal display panel according to claim 8, wherein
the step of forming the picture element electrode connected to the first electrode of the switching element includes a step of forming the picture element electrode into a predetermined shape by using a resist film having a predetermined pattern formed on a layer on which the picture element electrode is to be formed and performing patterning of the layer on which the picture element electrode is to be formed,
the step of forming the picture element electrode into the predetermined shape and the dividing step are one step, and
by using the resist film having the predetermined pattern formed on the layer on which the picture element electrode is to be formed and performing patterning of the layer on which the picture element electrode is to be formed, the first picture element electrode connected to the first electrode of the switching element and the second picture element electrode not connected to the first electrode of the switching element are formed.

13. The method for manufacturing the normally black-type liquid crystal display panel according to claim 8, wherein, at the step of forming the switching element, a driving circuit that controls a timing when the switching element is brought into an active state or an inactive state is formed on the first substrate.

14. The method for manufacturing the normally black-type liquid crystal display panel according to claim 13, wherein the driving circuit is provided in a region other than the display region of the first substrate.

15. The method for manufacturing the normally black-type liquid crystal display panel according to claim 13, wherein the driving circuit is provided in the display region of the first substrate.

16. The method for manufacturing the normally black-type liquid crystal display panel according to claim 8, wherein
before the step of bonding the one surface of the first substrate where the first picture element electrode and the second picture element electrode are formed and the one surface of the second substrate, a liquid crystal layer is formed by a liquid crystal dropping method on at least any one of the one surface of the first substrate and the one surface of the second substrate.

17. The method for manufacturing the normally black-type liquid crystal display panel according to claim 8, wherein
at the step of bonding the one surface of the first substrate where the first picture element electrode and the second picture element electrode are formed and the one surface of the second substrate, a liquid crystal filling port is formed by using a sealing material and the one surface of the first substrate and the one surface of the second substrate are bonded, and
after the step of bonding the one surface of the first substrate where the first picture element electrode and the second picture element electrode are formed and the one surface of the second substrate, between the one surface of the first substrate and the one surface of the second substrate which are bonded to each other, liquid crystal is filled via the liquid crystal filling port.
